(19) United States
(12) Patent Application Publication
(10) Pub. No.: US 2024/0160911 A1
(43) Pub. Date: May 16, 2024

(54) MACHINE LEARNING BASED CODE MAPPING

(71) Applicant: ADP, Inc., Roseland, NJ (US)

(72) Inventors: Hannah Guo, Pasadena, CA (US); Jeffrey M. Ku, Pasadena, CA (US); Roel Punzalan, Pasadena, CA (US); Mark E. Virgin, Pasadena, CA (US); Lei Xia, Parsippany, NJ (US)

(21) Appl. No.: 17/984,350

(22) Filed: Nov. 10, 2022

(51) Int. Cl. G06N 3/08

(52) U.S. Cl. CPC G06N 3/08

(57) ABSTRACT

Disclosed are various embodiments for machine learning based code mapping. A computing device can obtain a set of code identifiers. Then, the computing device can provide a first one of the set of code identifiers to a machine learning model and receive a potential classification from the machine learning model in response. Then, the computing device can determine that the confidence score for the potential classification meets or exceeds a predefined threshold value. In response, the computing device can then create a first mapping pair that links the first one of the set of code identifiers as being associated with the bucket.

### BACKGROUND

Data is often organized according to a schema, where different codes or identifiers within a schema can be used to identify specific types or instances of data. Many different data schemas can be used to define, identify, or represent data in a database. For example, two different organizations could use two different schemas to define or describe the same set of data. As another example, two different software applications could use different schemas to define the same set of data.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIGS. 4A-C is a pictorial diagram of an example user interface rendered by a client in the network environment of FIG. 1 according to various embodiments of the present disclosure.

### DETAILED DESCRIPTION

Disclosed are various approaches for machine learning based code mapping. Many software systems, such as payroll systems, can have a multitude of codes to classify different types of data. These codes can often be overly granular (e.g., multiple different codes for wages or base pay indicating which geographic region it originated from) or inconsistent (e.g., when different software systems use different codes to classify the same type of data). However, when analyzing or working with data sourced from multiple different organizations, a more general classification may be desired (e.g., a single classification for all types of wages or base pay regardless of geographic region or origin or regardless of the payroll system that originated the data). However, due to the large variety and inconsistency of codes that may be used between organizations or software platforms, a programmatic solution is often unable to process the various codes or correctly handle new or unrecognized codes.

To solve these problems, machine learning techniques can be used to accurately classify codes from disparate sources, including new, unrecognized, or previously unaddressed codes. By using machine learning to determine that a new, unrecognized, or previously unaddressed code is similar to other types of codes that have been categorized, data can be imported from a variety of sources without concern for whether the data schema of the source(s) is incompatible with existing mappings of codes to buckets or other classifications.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

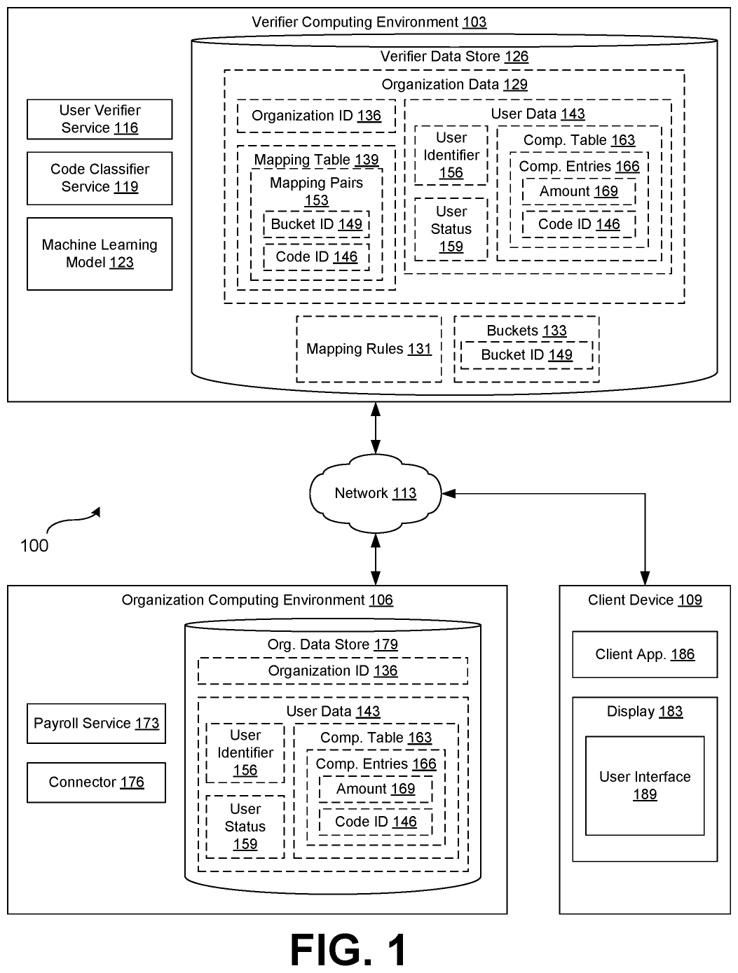

FIG. 1 depicts a network environment 100 according to various embodiments. The network environment 100 can include a verifier computing environment 103, an organization computing environment 106, and a client device 109, which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The verifier computing environment 103 and/or the organization computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the verifier computing environment 103 and/or the organization computing environment 106 can employ a plurality of computing devices that can be arranged in one or more server banks or computer banks or other arrangements. Such computing devices can be located in a single installation or can be distributed among many different geographical locations. For example, the verifier computing environment 103 and/or the organization computing environment 106 can include a plurality of computing devices that together can include a hosted computing resource, a grid computing resource or any other distributed computing arrangement. In some cases, the verifier computing environment 103 and/or the organization computing environment 106 can correspond to an elastic computing resource where the allotted capacity of processing, network, storage, or other computing-related resources can vary over time.

Various applications or other functionality can be executed in the verifier computing environment 103. The components executed on the verifier computing environment 103 can include a user verifier service 116, a code classifier service 119, and a machine learning model 123. Although depicted separately for illustrative purposes, the user verifier service 116, the code classifier service 119, and/or the machine learning model 123 could be deployed or implemented as components of the same application or service. Other applications, services, processes, systems, engines, or functionality not discussed in detail herein can also be executed in the verifier computing environment 103.

Also, various data is stored in a verifier data store 126 that is accessible to the verifier computing environment 103. The verifier data store 126 can be representative of a plurality of data stores, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the verifier data store 126 is associated with the operation of the various applications or functional entities described below. This data can include organization data 129, one or more mapping rules 131, one or more buckets 133, and potentially other data.

The organization data 129 can represent information about an organization, such as a company, enterprise, charity, or other organization. The organization data 129 for an organization can include information such as an organization identifier 136, a mapping table 139, and user data 143.

The organization identifier 136 can represent any unique identifier that can be used to distinguish one organization from another, and therefore one set of organization data 129 from another set of organization data 129. Examples of organization identifiers 136 can include names of an organization, tax identification numbers, randomly or sequentially generated identification numbers, etc.

The mapping table 139 can be used to map code identifiers 146 used by an organization to bucket identifiers 149 that identify individual buckets 133. As discussed later, an organization may use different types of code identifiers 146 to classify compensation paid to users. The relationship between individual code identifiers 146 used by an organization and bucket identifiers 149 used to identify buckets 133 may be stored as mapping pairs 153 in the mapping table 139. Each code identifier 146 used by an organization can have its own mapping pair 153 in the mapping table 139, although multiple code identifiers 146 could be mapped to the same bucket identifier 149.

The user data 143 can represent data about individual users, such as employees, contractors, owners, etc., associated with an organization. Each individual associated with the organization could, therefore, have their own set of user data 143. Each set of user data 143 can include a user identifier 156, a user status 159, a compensation table 163, and potential other data.

The user identifier 156 can represent any identifier that uniquely identifies one user with respect to another user. Examples of users identifiers 156 can include employee identification numbers, government issued identifiers, etc.

The user status 159 can represent the status of a user with respect to the organization. The user status 159 can include the nature of the relationship with the organization (e.g., employee, contractor, etc.), how long the user has had the relationship with the organization (e.g., employed for 5 years, contractor for 6 months, etc.), and current status of the relationship (e.g., current versus former employee or contractor). Other information could also be included in the user status 159 of individual users.

The compensation table 163 can include current and/or historical compensation information for individual users. For example, the compensation table 163 could include one or more compensation entries 166 detailing previous payments made to the user. Each compensation entry 166 in the compensation table 163 could include the amount 169 of the payment, the code identifier 146 identifying the type of payment, and potentially other information (e.g., the date and/or time the payment was made).

An organization may use different types of code identifiers 146 to classify compensation paid to users. For example, an organization could use one code identifier 146 to identify compensation as being for overtime, another code identifier 146 to identify compensation as deferred compensation, a third code identifier to identify compensation as being for wages, etc. Moreover, many organizations could use their own custom code identifiers 146 and code identifiers 146 used by one organization might not be used by another. For example, organizations that use different payroll services 173 may use different code identifiers 146. As another example, organizations could create code identifiers 146 for business purposes (e.g., one code identifier 146 to track payments associated with one jurisdiction, and another code identifier 146 to track payments associated with another jurisdiction). Code identifiers 146 can include numeric codes, alphanumeric codes (e.g., representing an abbreviation of a word or phrase), etc. Each code identifier 146 could also include a description of the code identifier 146. The description could include a word or short phrase that describes the code identifier 146.

The mapping rules 131 can represent rules for creating a mapping pair 153. Individual mapping rules 131 can specify, for example, that a given code identifier 146 (or set of code identifiers 146) should be mapped to a specified bucket identifier 149. Mapping rules 131 can be manually created or otherwise predefined, or can be created by the code classifier service 119 based on classifications made by the machine learning model 123.

The buckets 133 can represent classifications of compensation entries 166 used by the user verifier service 116. Each bucket 133 can represent a single type of compensation. For example, a first bucket 133 could be used to represent all types of wage or salary payments, a second bucket 133 could be used to represent all types of overtime payments, a third bucket 133 could be used to represent all types of expense reimbursements or per diem payments, etc. Accordingly, the buckets 133 allow for the user verifier service 116 to consolidate the multitude of code identifiers 146 used by different organizations, or the same organization, to identify the same type or class of payment made to individuals.

The user verifier service 116 can be executed to verify a user's employment status and/or income. For example, the user verifier service 116 can be configured to receive a verification request (e.g., from a bank, loan originator, landlord, etc.). In response, the user verifier service 116 can search for the user data 143 for the individual and provide information regarding the user's current user status 159 with an organization and/or a user's current income. This can allow third-parties to take into account a user's employment status, history, and income when making decisions such as extending a line of credit or a loan or entering into a contract (e.g., a lease, utility connection, etc.).

The code classifier service 119 can be executed to identify code identifiers 146 used by an organization for compensation entries 166 and determine which bucket identifier 149 a code identifier 146 should be mapped to. The code classifier service 119 can then create and store this information as a mapping pair 153 in a mapping table 139 for reference by the user verifier service 116. The code classifier service 119 could use predefined mapping rules 131 to determine which bucket identifier 149 a code identifier 146 should be mapped to. If a mapping rule 131 does not exist for a code identifier 146, the code classifier service 119 could provide the code identifier 146 to the machine learning model 123 to predict which bucket identifier 149 the code identifier 146 should be mapped to.

The machine learning model 123 can be executed to predict which bucket identifier 149 an unmapped code identifier 146 should be mapped to. In some implementations, the machine learning model 123 can be a neural network that has been trained using known mapping pairs 153 to determine which types of code identifiers 146 are typically linked to individual bucket identifiers 149. The machine learning model 123 could, therefore, determine which code identifiers 146 with a similar description or identifier have been mapped to a bucket identifier 149 and return that bucket identifier 149 as a predicted bucket identifier 149 to be used for the code identifier 146.

Various applications or other functionality can be executed in the organization computing environment 106. The components executed on the organization computing environment 106 include a payroll service 173 and a connector 176. Other applications, services, processes, systems, engines, or functionality not discussed in detail herein could also be executed within the organization computing environment 106.

Also, various data is stored in an organization data store 179 that is accessible to the organization computing environment 106. The organization data store 179 can be representative of a plurality of data stores, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the organization data store 179 is associated with the operation of the various applications or functional entities described below. This data can include an organization identifier 136 for the organization, user data 143 for individual users affiliated with the organization, and potentially other data.

The payroll service 173 can be executed to by an organization to perform or process payroll events. For example, the payroll service 173 could periodically (e.g., weekly, bi-weekly, semi-monthly, monthly, etc.) process payroll for an organization, thereby causing funds to be deposited into a user's bank account or for a check to be issued for the user. The payroll service 173 can also be used to process out-of-cycle payroll events (e.g., a final payment to a departing employee, an expense reimbursement, etc.). Whenever a payroll event occurs, the payroll service 173 can update the user data 143 for individual users to add one or more compensation entries 166 to the compensation table 163 of the user.

The connector 176 can be executed to monitor the operations of the payroll service 173 and provide updated user data 143 to the verifier data store 126. For example, the connector 176 could be executed to detect the occurrence of events involving the payroll service 173 and, in response, copy new or updated user data 143 from the organization data store 179 to the verifier data store 126.

The client device 109 is representative of a plurality of client devices that can be coupled to the network 113. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays 183, such as liquid crystal displays (LCDs), gas plasma-based flat panel displays, organic light emitting diode (OLED) displays, electrophoretic ink (“E-ink”) displays, projectors, or other types of display devices. In some instances, the display 183 can be a component of the client device 109 or can be connected to the client device 109 through a wired or wireless connection.

The client device 109 can be configured to execute various applications such as a client application 186 or other applications. The client application 186 can be executed by the client device 109 to access network content served up by the verifier computing environment 103 or other servers, thereby rendering a user interface 189 on the display 183. To this end, the client application 186 can include a browser, a dedicated application, or other executable, and the user interface 189 can include a web page, an application screen, or other user mechanism for obtaining user input. The client device 109 can be configured to execute applications beyond the client application 186 such as email applications, social networking applications, word processors, spreadsheets, or other applications.

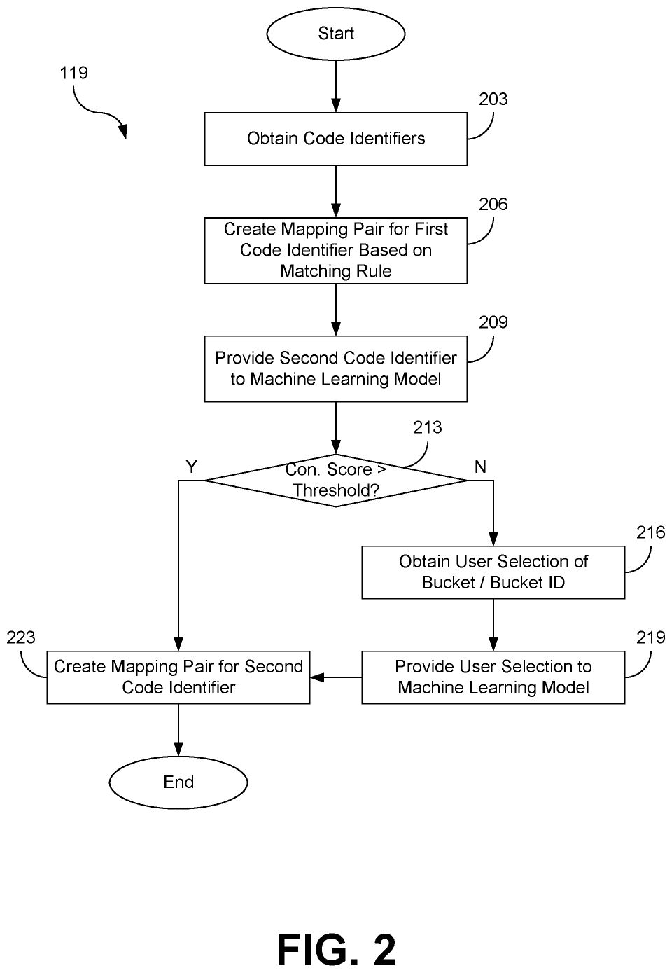

Next, a general description of the operation of the various components of the network environment 100 is provided. Although the following general description provides an example of interactions between the various components of the network environment 100, other interactions are also possible in various embodiments of the present disclosure. More detailed descriptions are set forth in the discussion accompanying FIGS. 2-4C.

To begin, an organization can enable the user verifier service 116 for users in the organization. As part of the process, the organization could cause the connector 176 to be installed and/or enabled in the organization computing environment 106.

Then, the organization could also upload user data 143 to the verifier data store 129 and upload the code identifiers 146 used by the organization to the code classifier service 119 data store 126. For example, the organization could programmatically send the code identifiers 146 to the code classifier service 119 using one or more application programming interface (API) function calls provided by the code classifier service 119. As another example, someone in the organization could manually upload a file containing all of the code identifiers 146 used by the organization.

The code classifier service 119 can then create mapping pairs 153 for the code identifiers 146 and store the mapping pairs 153 in the mapping table 139 for the organization. For example, the code classifier service 119 could execute one or more predefined mapping rules 131 to map well-known or previously mapped code identifiers 146 to particular bucket identifiers 149. For instance, default code identifiers 146 used by various payroll services 173 could have predefined mapping rules 131 that could be used by the code classifier service 119.

The code classifier service 119 could then provide any unclassified code identifiers 146 to the machine learning model 123. The machine learning model 123 could then analyze each unclassified code identifier 146 and predict which bucket identifier 149 is most likely to be associated with the unclassified code identifier 146. The prediction could also include a confidence score to indicate how strong the association is. In some implementations, multiple potential classifications could be returned by the machine learning model 123, which could be ranked based at least in part on the respective confidence scores.

The code classifier service 119 can select one of the potential classifications and save it as a mapping pair 153. For example, the code classifier service 119 could select a potential classification if the confidence score meets or exceeds a predefined threshold. If no potential classification has a high enough confidence score, or if multiple potential classifications have a confidence score that meets or exceeds the predefined threshold, then the code classifier service 119 can send a request to the client application 186 to show a user interface 189 on the display 183 of the client device 109 to obtain a user input or selection regarding the appropriate bucket 133, and therefore bucket identifier 149, that the unclassified code identifier 146 should be associated with.

After obtaining the user selection, the code classifier service 119 can create a mapping pair 153 between the code identifier 146 and the selected bucket 133 and/or bucket identifier 149. The user selection can also be fed back to the machine learning model 123 to further train the machine learning model 123 and improve its classification predictions.

Referring next to FIG. 2, shown is a flowchart that provides one example of the operation of a portion of the code classifier service 119. The flowchart of FIG. 2 provides merely an example of the many different types of functional arrangements that can be employed to implement the operation of the depicted portion of the code classifier service 119. As an alternative, the flowchart of FIG. 2 can be viewed as depicting an example of elements of a method implemented within the network environment 100.

Beginning with block 203, the code classifier service 119 can obtain a set of one or more code identifiers 146 for an organization. For example, the code classifier service 119 could receive a file upload (e.g., a tab or comma separated value text file, a spreadsheet, etc.), wherein the file contains the code identifiers 146. As another example, the code classifier service 119 could receive the code identifiers 146 via an API call (e.g., from the connector 176).

Then, at block 206, the code classifier service 119 can apply matching rules 131 to the set of code identifiers 146 to attempt to match at least one code identifier 146 with at least one bucket identifier 149. This step may be performed as a performance optimization to avoid using the additional computation resources required by the machine learning model 123 to classify code identifiers 146. For each code identifier 146 that satisfies a matching rule 131, the code classifier service 119 could create a respective mapping pair 153 in the mapping table 139 for the organization data 129 of the organization.

Next, at block 209, the code classifier service 119 can provide any code identifiers 146 that were not matched by a matching rule 131 to the machine learning model 123 for classification. The code classifier service 119 can receive proposed classifications for each code identifier 146 provided to the machine learning model 123. Each proposed classification could include the bucket identifier 149 of the bucket 133 that the machine learning model 123 has identified as being a likely match for the code identifier 146. Each proposed classification could also include a confidence score indicating how likely the machine learning model 123 believes its prediction is to be correct (e.g., based at least in part on how similar the machine learning model 123 has determined the code identifier 146 is to other code identifiers 146 associated with the bucket identifier 149 of the bucket 133).

Moving to block 213, the code classifier service 119 can evaluate the proposed classification(s) provided by the machine learning model 123. If only a single proposed classification is proposed, then the code classifier service 119 could determine whether its confidence score meets or exceeds a predefined threshold. Similarly, if multiple proposed classifications are returned, then the code classifier service 119 could determine if any of the multiple proposed classifications meet or exceed a predefined threshold. If only one proposed classification has a confidence score that meets or exceeds the predefine threshold, then the process can proceed to block 223. However, if none of the proposed classifications meet or exceed the predefined threshold, or if multiple proposed classifications meet or exceed the predefined threshold, then the process can continue to block 216

If the process proceeds to block 216, the code classifier service 119 can obtain a user selection of a bucket identifier 149 for a bucket 133. For example, the code classifier 119 could send data regarding the proposed classification to a client application 186 executing on the client device 109, such as the bucket identifier 149 and the bucket 133 proposed by the machine learning model 123, the confidence score returned by the machine learning model 123, etc. If there were multiple potential classifications, information for each proposed classification could be provided to the client application 186 executing on the client device 109.

The client application 186 could then cause the client device 109 to generate a user interface 189 (e.g., a webpage, an application screen, etc.) and show it on the display 183 of the client device 109. The user interface 189 could show the proposed classifications and provide a user with the opportunity to select the correct bucket identifier 149 for a bucket 133. The client application 186 could then return the user's selection to the code classifier service 119.

Then, at block 219, the code classifier service 119 could provide the user selection to the machine learning model 123, thereby allowing the machine learning model 123 to continue to train itself in order to provide more accurate classifications. Optionally, at this point in the process, the code classifier service 119 could create and save a new mapping rule 131 for future classifications. The new mapping rule 131 could, for example, be used to match the code identifier 146 with the selected bucket identifier 149 for the bucket 133 in the future without having to involve the machine learning model 123.

Subsequently, at block 223, the code classifier service 119 can create and save a mapping pair 153 in the mapping table 139 for the previously unclassified code identifier 146 that links the code identifier 146 to the bucket identifier 149 of the bucket 133 identified by the machine learning model 123 or the user. Once the mapping pair 153 has been created and saved, the process can end.

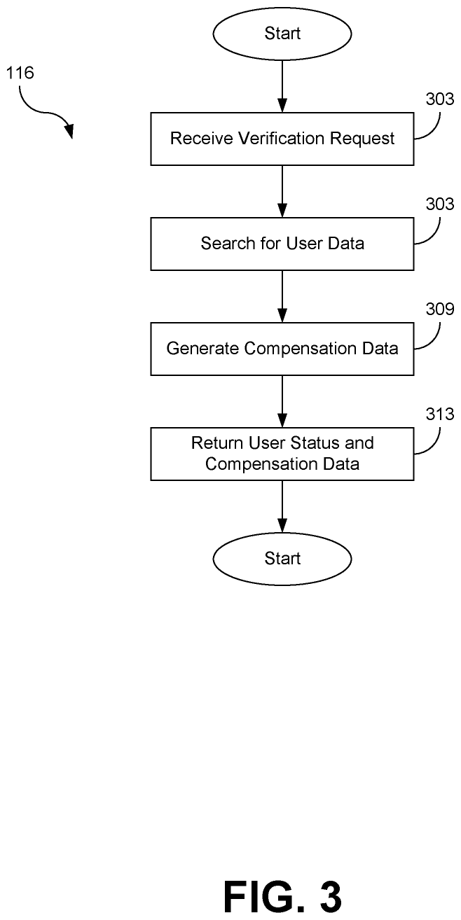

Referring next to FIG. 3, shown is a flowchart that provides one example of the operation of a portion of the user verifier service 116. The flowchart of FIG. 3 provides merely an example of the many different types of functional arrangements that can be employed to implement the operation of the depicted portion of the user verifier service 116. As an alternative, the flowchart of FIG. 3 can be viewed as depicting an example of elements of a method implemented within the network environment 100.

Beginning with block 303, the user verifier service 116 can receive a verification request from a third-party. The verification request could request information related to the current status of a user with an organization and/or the current compensation of the user. The verification request could be received, for example, from a bank or other loan originator, insurance company, utility company, landlord, etc. in order to verify that the user's current employment and/or income. Accordingly, the verification request could include the user identifier 156 of the user to be verified and/or the organization identifier 136 of the organization that the user is affiliated with (e.g., the user's employer).

Then, at block 306, the user verifier service 116 can search for the user data 143 of the user identified in the verification request received at block 303. For example, if the verification request includes the user identifier 156, then the user verifier service 116 could search the organization data 129 for each organization to find matching user data 143 for the identified user. If the verification request includes both the user identifier 156 of the user and the organization identifier 136 of the organization (e.g., the user's employer), then the user verifier service 116 could perform an optimized request to search only the organization data 129 that matches the organization identifier 136 in order to find user data 143 that matches the user identifier 156 provided in the verification request.

Next, at block 309, the user verifier service 116 can generate the compensation data by cross-referencing the compensation entries 166 saved in the user data 143 of the user to the mapping pairs 153 saved in the mapping table 139 of the organization data 129 of the organization the user is associated with. For example, the verification request may wish to verify the total wages of the user, excluding overtime, bonuses, etc. However, there may be multiple code identifiers 146 that represent wage income. In order to determine which compensation entries 166 reflect wage income of the user, the user verifier service 116 could search the mapping pairs 153 of the organization data 129 for those mapping pairs 153 with a bucket identifier 149 for the bucket 133 that reflects wage income. The user verifier service 116 could then select the compensation entries 166 with a code identifier 146 that is present in at least one of the mapping pairs 153 with a bucket identifier 149 for the bucket 133 that reflects wage income and sum the amounts 169 of the compensation entries 166 to calculate the wage income of the user. Similar queries and calculations could be performed to calculate the amount for other compensation criteria.

Subsequently, at block 313, the user verifier service 116 can return the requested data. This can include the user status 159 and/or the compensation data generated at block 309. Once the requested data has been returned, the process can end.

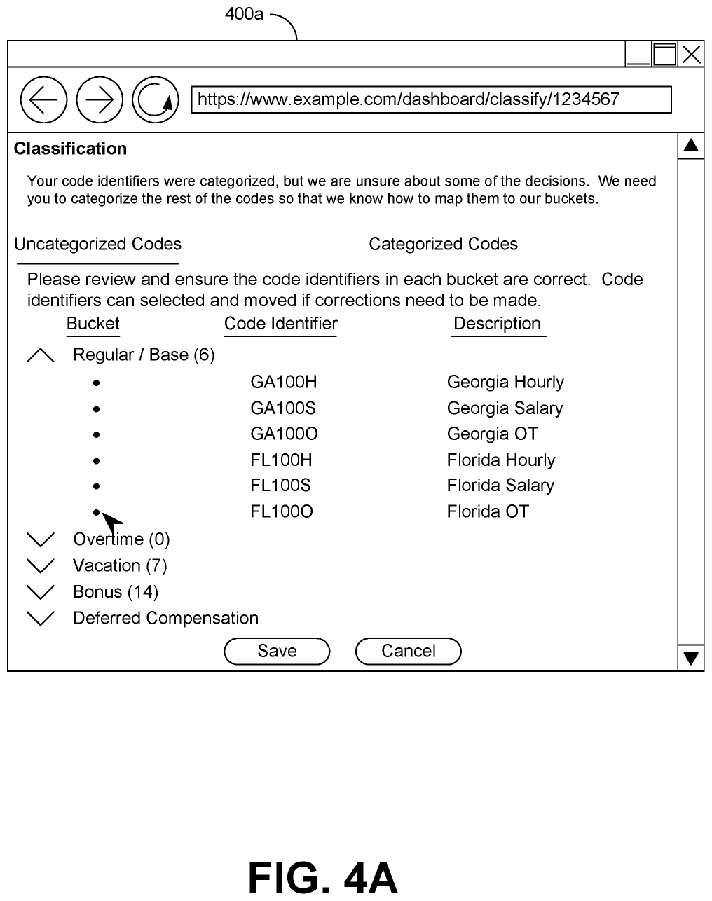

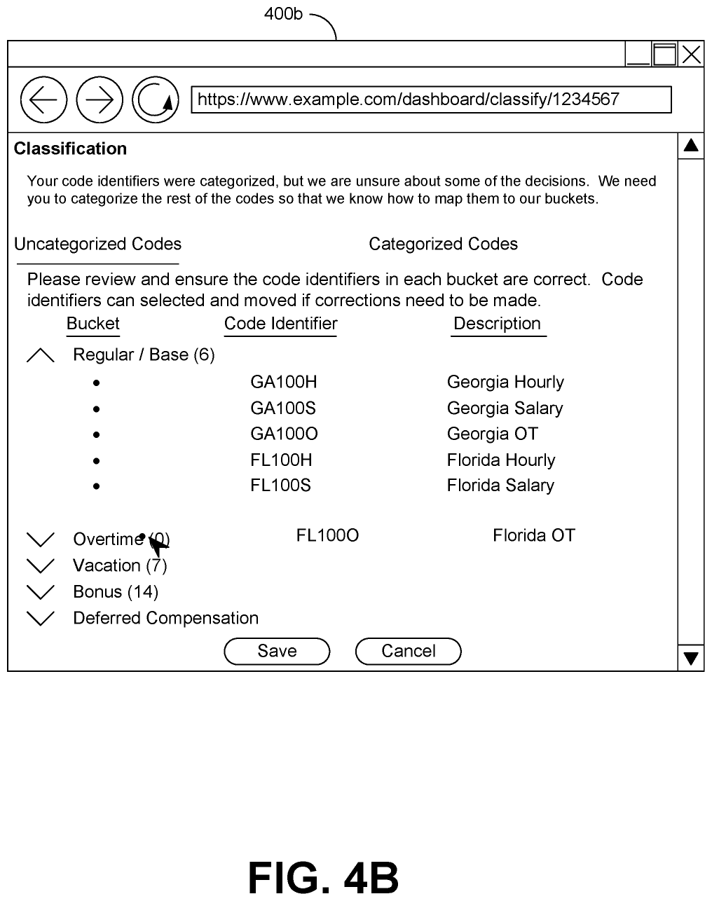

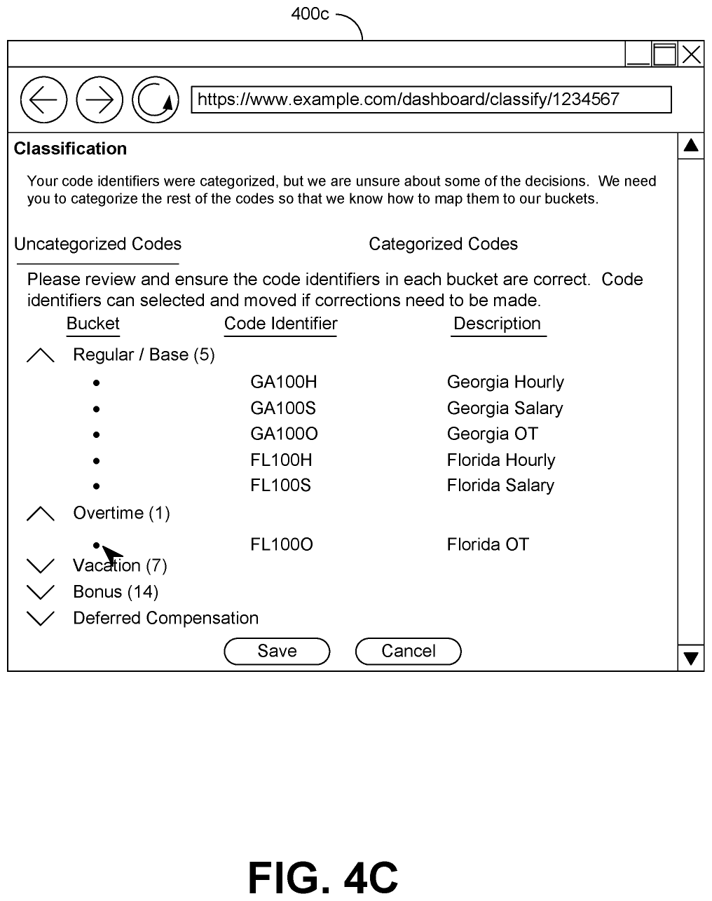

Referring next to FIG. 4A, shown is an example of a user interface 189 in the form of a web page 400a. As previously discussed, once the machine learning model 123 has classified one or more code identifiers 146, the code classifier service 119 can send any code identifiers 146 that have not been classified in a bucket 133 (e.g., because no potential classification has a high enough confidence score or because multiple potential classifications have a sufficiently high confidence score to be a likely match) to the client application 186 to obtain user inputs or selections of an appropriate classification. The code identifiers 146 could be presented as uncategorized or unclassified code identifiers 146, with a proposed classification in the bucket 133 with the highest confidence score provided by the machine learning model 123.

Turning now to FIG. 4B, shown is an example of a user interface 189 in the form of a web page 400b. As previously mentioned, the code identifiers 146 could be presented as uncategorized or unclassified code identifiers 146, with a proposed classification in the bucket 133 with the highest confidence score provided by the machine learning model 123. In the web page 400b, the user is illustrated as moving a code identifier 146 from a first classification of a first bucket 133 (illustrated as “Regular/Base” compensation) to a second bucket 133 that the user deems to be more appropriate (illustrated as “Overtime”) in order to appropriately classify the code identifier 146 in the correct bucket 133.

Moving on to FIG. 4C, shown is an example of a user interface 189 in the form of a web page 400c. Here, the code identifier 146 has been reclassified to the “Overtime” bucket 133 as a result of the drag-and-drop operation previously depicted in FIG. 4B. Should the user wish to confirm or preserve the classification, the user could then use the depicted mouse cursor to select the “save” button, thereby indicating to the code classifier service 119 that all of the current classifications of should be saved as mapping pairs 153. The uncategorized code identifiers 146 would then become categorized code identifiers 146 as a result of the user confirmation after any changes have been made.

The same user interface 189 could similarly be used to allow a user to confirm the buckets 133 that the code classifier service 119 has classified other code identifiers 146 into. For example, a user could select the “Categorized Codes” depicted in the user interfaces 4A-4C to same the same or similar user interface 189, which would depict all of the buckets 133 and all of the code identifiers 146 that have been classified based on either a matching rule 131 or a confidence score for a machine learning model 123 classification meeting or exceeding a predefined threshold or other criteria, similar to what is depicted in FIG. 4A. The user could then drag-and-drop individual code identifiers 146 from one bucket 133 to another bucket 133 to reclassify the code identifiers 146 (e.g., to correct an error made by the code classifier service 119 or the machine learning model 123), similar to what is depicted in FIG. 4B. The user could then see the reclassifications and confirm them in a manner similar to what is depicted in FIG. 4C.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
obtain a set of code identifiers;
provide a first one of the set of code identifiers to a machine learning model, wherein the machine learning model is trained to identify a potential classification for the first one of the code identifiers, wherein the potential classification identifies a bucket and comprises a confidence score for the potential classification;
receive the potential classification from the machine learning model;
determine that the confidence score for the potential classification meets or exceeds a predefined threshold value; and
in response to a determination that the confidence score meets or exceeds the predefined threshold value, create a first mapping pair that links the first one of the set of code identifiers as being associated with the bucket.

2. The system of claim 1, wherein the potential classification is a first potential classification, the confidence score is a first confidence score, and the machine-readable instructions further cause the computing device to at least:
provide a second one of the set of code identifiers to the machine learning model to identify a second potential classification for the second one of the set of code identifiers, the second potential classification identifies the bucket and comprises a second confidence score for the second potential classification;
receive the second potential classification from the machine learning model;
determine that the second confidence score fails to meet or exceed the predefined threshold;
obtain a user classification of the second one of the set of code identifiers in response to a determination that the second confidence score fails to meet or exceed the predefined threshold; and
create a second mapping pair that links the second one of the set of code identifiers as being associated with the bucket.

3. The system of claim 2, wherein the machine-readable instructions that cause the computing device to obtain the user classification further cause the computing device to at least:
send the second potential classification to a client application executing on a client device; and
receive the user classification from the client application executing on the client device.

4. The system of claim 2, wherein the machine-readable instructions further cause the computing device to at least provide the user classification received from the client to the machine learning model to further train the machine learning model.

5. The system of claim 1, wherein the machine-readable instructions further cause the computing device to at least:
apply at least one matching rule to the set of code identifiers to classify one or more of the set of code identifiers as being associated with the bucket; and
in response to one or more of the set of code identifiers being associated with the bucket based at least in part on the at least one matching rule, create a second mapping pair that links the one or more of the set of code identifiers as being associated with the bucket.

6. The system of claim 5, wherein the machine-readable instructions further cause the computing device to at least:
generate an additional matching rule to reflect the classification of the first one of the code identifiers as being associated with the bucket; and
save the additional matching rule.

7. The system of claim 1, wherein the machine learning model comprises a neural network.

8. A method, comprising:
obtaining a set of code identifiers;
providing a first one of the set of code identifiers to a machine learning model, wherein the machine learning model is trained to identify a potential classification for the first one of the code identifiers, wherein the potential classification identifies a bucket and comprises a confidence score for the potential classification;
receiving the potential classification from the machine learning model;
determining that the confidence score for the potential classification meets or exceeds a predefined threshold value; and
in response to determining that the confidence score meets or exceeds the predefined threshold value, creating a first mapping pair that links the first one of the set of code identifiers as being associated with the bucket.

9. The method of claim 8, wherein the potential classification is a first potential classification, the confidence score is a first confidence score, and the method further comprises:
providing a second one of the set of code identifiers to the machine learning model to identify a second potential classification for the second one of the set of code identifiers, the second potential classification identifies the bucket and comprises a second confidence score for the second potential classification;
receiving the second potential classification from the machine learning model;
determining that the second confidence score fails to meet or exceed the predefined threshold;
obtaining a user classification of the second one of the set of code identifiers in response to determining that the second confidence score fails to meet or exceed the predefined threshold; and
creating a second mapping pair that links the second one of the set of code identifiers as being associated with the bucket.

10. The method of claim 9, further comprising:
sending the second potential classification to a client application executing on a client device; and
receiving the user classification from the client application executing on the client device.

11. The method of claim 9, further comprising providing the user classification received from the client to the machine learning model to further train the machine learning model.

12. The method of claim 8, further comprising:
applying at least one matching rule to the set of code identifiers to classify one or more of the set of code identifiers as being associated with the bucket; and
in response to one or more of the set of code identifiers being associated with the bucket based at least in part on the at least one matching rule, creating a second mapping pair that links the one or more of the set of code identifiers as being associated with the bucket.

13. The method of claim 12, further comprising:
generating an additional matching rule to reflect the classification of the first one of the code identifiers as being associated with the bucket; and
saving the additional matching rule.

14. The method of claim 8, wherein the machine learning model comprises a neural network.

15. A non-transitory, computer-readable medium, comprising machine-readable instructions that, when executed by a processor of a computing device, cause the computing device to at least:
obtain a set of code identifiers;
provide a first one of the set of code identifiers to a machine learning model, wherein the machine learning model is trained to identify a potential classification for the first one of the code identifiers, wherein the potential classification identifies a bucket and comprises a confidence score for the potential classification;
receive the potential classification from the machine learning model;
determine that the confidence score for the potential classification meets or exceeds a predefined threshold value; and
in response to a determination that the confidence score meets or exceeds the predefined threshold value, create a first mapping pair that links the first one of the set of code identifiers as being associated with the bucket.

16. The non-transitory, computer-readable medium of claim 15, wherein the potential classification is a first potential classification, the confidence score is a first confidence score, and the machine-readable instructions further cause the computing device to at least:
provide a second one of the set of code identifiers to the machine learning model to identify a second potential classification for the second one of the set of code identifiers, the second potential classification identifies the bucket and comprises a second confidence score for the second potential classification;
receive the second potential classification from the machine learning model;
determine that the second confidence score fails to meet or exceed the predefined threshold;
obtain a user classification of the second one of the set of code identifiers in response to a determination that the second confidence score fails to meet or exceed the predefined threshold; and
create a second mapping pair that links the second one of the set of code identifiers as being associated with the bucket.

17. The non-transitory, computer-readable medium of claim 16, wherein the machine-readable instructions that cause the computing device to obtain the user classification further cause the computing device to at least:
send the second potential classification to a client application executing on a client device; and
receive the user classification from the client application executing on the client device.

18. The non-transitory, computer-readable medium of claim 16, wherein the machine-readable instructions further cause the computing device to at least provide the user classification received from the client to the machine learning model to further train the machine learning model.

19. The non-transitory, computer-readable medium of claim 15, wherein the machine-readable instructions further cause the computing device to at least:
apply at least one matching rule to the set of code identifiers to classify one or more of the set of code identifiers as being associated with the bucket; and
in response to one or more of the set of code identifiers being associated with the bucket based at least in part on the at least one matching rule, create a second mapping pair that links the one or more of the set of code identifiers as being associated with the bucket.

20. The non-transitory, computer-readable medium of claim 19, wherein the machine-readable instructions further cause the computing device to at least:
generate an additional matching rule to reflect the classification of the first one of the code identifiers as being associated with the bucket; and
save the additional matching rule.
